(19) United States
(12) Patent Application Publication
(10) Pub. No.: US 2019/0066414 A1
(43) Pub. Date: Feb. 28, 2019

(54) AUTHENTICATION CONTROL SYSTEM FOR A VEHICLE

(71) Applicant: Faraday&Future Inc.

(72) Inventors: Daniel L. Kowalewski, Redondo Beach, CA (US); Matthew Richard Partsch, San Pedro, CA (US)

(21) Appl. No.: 15/772,039

(22) PCT Filed: Oct. 21, 2016
(86) PCT No.: PCT/US2016/058058

§ 371 Date: Apr. 27, 2018

Related U.S. Application Data
(60) Provisional application No. 62/248,500, filed on Oct. 30, 2015.

(51) Int. Cl. G07C 9/00; B60R 25/25; B60R 25/24; B60R 25/23

(52) U.S. Cl. CPC G07C 9/00087; B60R 25/25; G07C 2209/04; B60R 25/23; B60R 2325/205; B60R 25/24

(57) ABSTRACT

An authentication control system for a vehicle may include an interface configured to receive a first signal generated by a primary authentication mechanism, and receive a second signal generated by a secondary authentication mechanism. The authentication control system may also include a processing unit configured to enable a first set of parameters of the vehicle based on receiving the first signal and not the second signal, and enable a second set of parameters of the vehicle based on receiving the first signal and the second signal; wherein the second set of parameters are different than the first set of parameters.

### CROSS REFERENCE TO RELATED APPLICATIONS

This application claims the benefit of priority from U.S. Provisional Patent Application No. 62/248,500 filed on Oct. 30, 2015, the entire disclosures of which is incorporated by reference.

### TECHNICAL FIELD

The present disclosure relates generally to a system for a vehicle, and more particularly, to an authentication control system for a vehicle.

### BACKGROUND

There are many situations that arise when a vehicle owner may need to allow access of the vehicle to another person (e.g., a parking attendant, a mechanic, an associate, a child, or a spouse). Under these circumstances it may be desirable to limit access to various features of the vehicle to ensure the safety or privacy of his/her vehicle. Limiting access to the vehicle has recently become even more desirable with the development of modem vehicle technology, such as internet access, infotainment systems, social media access, private access codes, garage door activators, sport performance modes, etc.

Prior attempts to address this problem include providing a “valet” key which allows entry into the vehicle while preventing access to certain compartments, such as a glove box or a trunk. The valet key is successful in addressing the problem to an extent, but it does not limit the performance of the vehicle nor does it address modern vehicle technology.

The disclosed authentication control system is directed to mitigating or overcoming one or more of the problems set forth above and/or other problems in the prior art.

### SUMMARY

One aspect of the present disclosure is directed to an authentication control system for a vehicle. The authentication control system may include an interface configured to receive a first signal generated by a primary authentication mechanism, and receive a second signal generated by a secondary authentication mechanism. The authentication control system may also include a processing unit configured to enable a first set of parameters of the vehicle based on receiving the first signal and not the second signal, and enable a second set of parameters of the vehicle based on receiving the first signal and the second signal, wherein the second set of parameters are different than the first set of parameters.

Another aspect of the present disclosure is directed to a vehicle including an authentication control system. The authentication control system may include an interface configured to receive a first signal generated by a primary authentication mechanism, and receive a second signal generated by a secondary authentication mechanism. The authentication control system may also include a processing unit configured to enable a first set of parameters of the vehicle based on receiving the first signal and not the second signal, and enable a second set of parameters of the vehicle based on receiving the first signal and the second signal, wherein the second set of parameters are different than the first set of parameters.

Yet another aspect of the present disclosure is directed to a method of authentication for a vehicle. The method may include querying a primary authentication mechanism and a secondary authentication mechanism, enabling a first set of parameters based on detecting the primary authentication mechanism and not the secondary authentication mechanism, and enabling a second set of parameters based on detecting the primary authentication mechanism and the secondary authentication mechanism

### BRIEF DESCRIPTION OF THE DRAWINGS

FIG. 1 is a diagrammatic illustration of an exemplary embodiment of an exemplary vehicle;

FIG. 2 is a diagrammatic illustration of an exemplary embodiment of an interior of the exemplary vehicle of FIG. 1;

FIG. 3 is a block diagram of an exemplary authentication control system that may be used with the exemplary vehicle of FIGS. 1-2, according to an exemplary embodiment of the disclosure; and

FIG. 4 is a flowchart illustrating an exemplary process that may be performed by the exemplary authentication control system of FIG. 3, according to an exemplary embodiment of the disclosure.

### DETAILED DESCRIPTION

The disclosure is generally directed to an authentication/detection control system for a vehicle that may limit access to various features of a vehicle. In some embodiments, the authentication control system may include a two (or more) level verification scheme for vehicle authentication/security. For example, the authentication control system may be in communication with a primary authentication mechanism that when detected may enable a first set of vehicle parameters, and a secondary authentication mechanism that, when detected with the secondary authentication mechanism, may enable a second set of parameters.

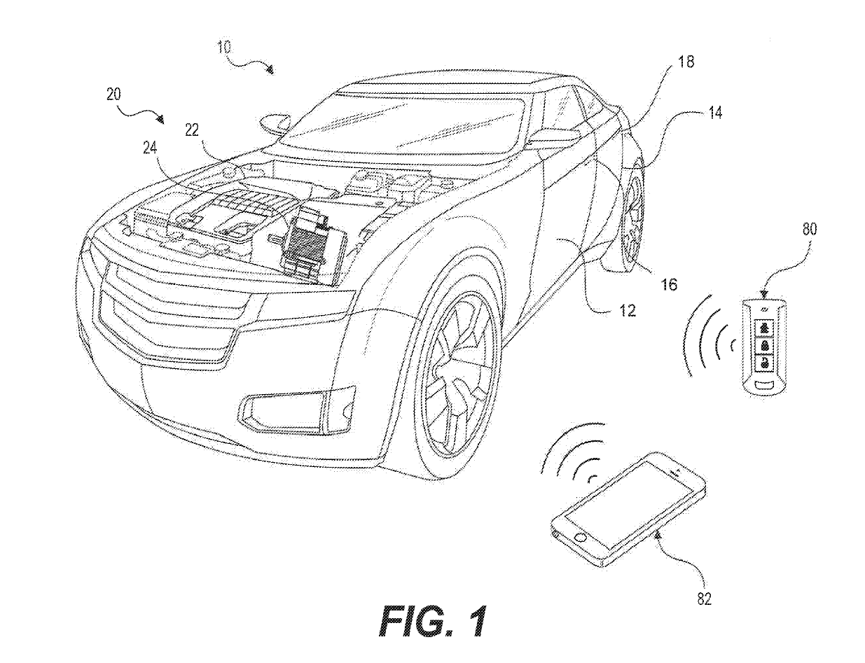

FIG. 1 is a diagrammatic illustration of an exemplary embodiment of an exemplary vehicle 10. Vehicle 10 may have any body style, such as a sports car, a coupe, a sedan, a pick-up truck, a station wagon, a sports utility vehicle (SUV), a minivan, or a conversion van. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous. As illustrated in FIG. 1, vehicle 10 may include a plurality of doors 12, 14 that allow access to an interior and each secured with respective locks 16, 18. For example, vehicle 10 may include a driver side door 12 secured by a driver side lock 16, and a passenger side door 14 secured by a passenger side lock 18.

Vehicle 10 may also include a powertrain 20 having a power source 22, a motor 24, and optionally a transmission (not shown). In some embodiments, power source 22 may be configured to output power to motor 24, which drives the transmission to generate kinetic energy through wheels of vehicle 10. Power source 22 may also be configured to provide power to other components of vehicle 10, such as audio systems, user interfaces, heating, ventilation, air conditioning (HVAC), etc. Power source 22 may include a plug-in battery or a hydrogen fuel-cell. It is also contemplated that in some embodiments powertrain 20 may include or be replaced by a conventional internal combustion engine.

Vehicle 10 may further be in communication with a primary authentication mechanism 80 and a secondary authentication mechanism 82. Primary and secondary authentication mechanisms 80, 82 may include a number of different structures. In some embodiments, authentication mechanisms 80, 82 may include a radio frequency security fob configured to generate a signal detectable by vehicle 10. In some embodiments, authentication mechanisms 80, 82 may include a mobile communication device configured to generate a wired or wireless signal detectable by vehicle 10. For example, the mobile communication device may include a smart phone configured to connect to vehicle 10 via a nationwide cellular network, a local wireless network (e.g., Bluetooth™ or WiFi), and/or a wired network. In some embodiments, authentication mechanisms 80, 82 may include the entry of an access code into one of a user interface of vehicle 10 or a mobile communication device connected to vehicle 10. In some embodiments, authentication mechanisms 80, 82 may include acquisition of biometric data, such as detecting one or more stored fingerprints detectable on a touch-sensitive surface.

Primary authentication mechanism 80 may include a first structure that is different than a second structure of secondary authentication mechanism 82. For example, primary authentication mechanism 80 may include a radio frequency security fob, while secondary authentication mechanism 82 may include a Bluetooth™ signal generated by one or more smart phones in the possession of select individual(s) associated with vehicle 10. In another example, primary authentication mechanism 80 may include an interface that receives an access code, while secondary authentication mechanism 82 may include stored fingerprint(s) of select individual(s) associated with vehicle 10. In yet another example, primary authentication mechanism 80 may include a radio frequency security fob, while secondary authentication mechanism 82 may include stored fingerprint(s) of select individual(s) associated with vehicle 10. However, it is also contemplated that primary and secondary authentication mechanisms 80, 82 may include similar structures. For example, primary authentication mechanism 80 and secondary authentication mechanism 82 may include radio frequency security fobs, each programmed for emitting different signals, thus accessing different features of vehicle 10.

Primary authentication mechanism 80 and/or secondary authentication mechanism 82 may be programmed to be associated with a variety of different users of vehicle 10. For example, a primary authentication mechanism 80 may be programmed to be associated with a parking attendant and enable a first set of parameters. Another primary authentication mechanism 80 may be programmed to be associated with a teenager and enable a first set of parameters, different than the first set of parameters for the parking attendant. A primary and/or a secondary authentication mechanism 80, 82 may be programmed to be associated with an owner of vehicle 10 and enable a second set of parameters. In some embodiments, vehicle 10 may be configured to recognize authentication mechanisms 80, 82 based on data stored in a controller onboard vehicle 10. For example, the stored data may include the person's name, the person's relationship with vehicle 10, and a digital signature of authentication mechanism 80, 82. The digital signature of authentication mechanisms 80, 82 may be according to a determinative emitted radio frequency (RF) or a GPS tag.

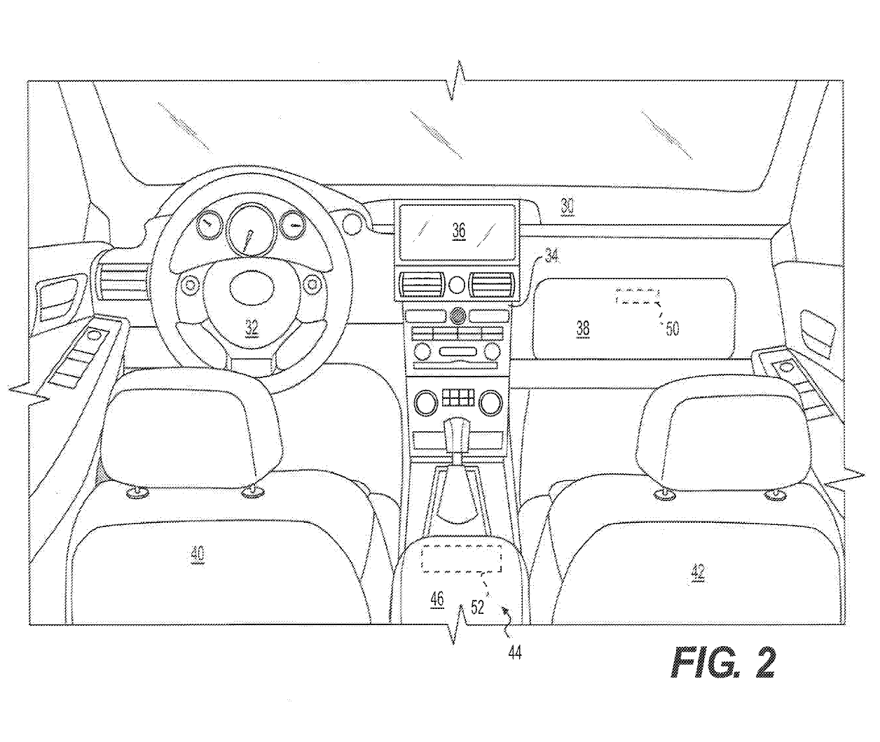

FIG. 2 is a diagrammatic illustration of an exemplary embodiment of an interior of the exemplary vehicle of FIG. 1. As illustrated in FIG. 2, vehicle 10 may have a dashboard 30 that may house or support a steering wheel 32, an audio system 34, a user interface 36, and a dashboard compartment 38. Vehicle 10 may also have a first front seat 40 and a second front seat 42 configured to accommodate occupants and separated by a center console 44. Center console 44 may include a center compartment 46.

Compartments 38, 46 may be interior compartments selectively accessed in a number of different manners. In some embodiments, dashboard compartment 38 may be secured with a dashboard lock 50, and center compartment 46 may be secured with a center lock 52. Compartment locks 50, 52 may be in wired or wireless communication with authentication mechanism(s) 80, 82. For example, the presence of a radio frequency security fob and/or a smartphone may allow access to compartments 38, 46. An interface may also be provided on a surface of compartments 38, 46 and receive biometric data (e.g., fingerprints) and/or an access code to allow access. Vehicle 10 may have additional compartments positioned anywhere in vehicle 10 and similarly selectively accessed through locks.

User interface 36 may be configured to receive input from the user and transmit data. For example, user interface 36 may have a display including an LCD, an LED, a plasma display, or any other type of display, and provide a Graphical User Interface (GUI) presented on the display for user input and data display. User interface 36 may further include input devices, such as a touchscreen, a keyboard, a mouse, and/or a tracker ball. User interface 36 may further include a housing having grooves containing the input devices and configured to receive individual fingers of the user. User interface 36 may be configured to provide internet access, cell phone access, and/or in-vehicle network access, such as Bluetooth™, CAN bus, or any other vehicle bus architecture protocol that may be used to access features or calibrations within vehicle 10. User interface 36 may be configured to display other media, such as movies and/or television. User interface 36 may further provide an interface for authentication control mechanisms 80, 82. For example, user interface 36 may include a touchscreen configured to recognize an occupant by detecting biometric data, such as fingerprint(s). The touchscreen may also be configured to provide a keypad through which the occupant may enter an access code.

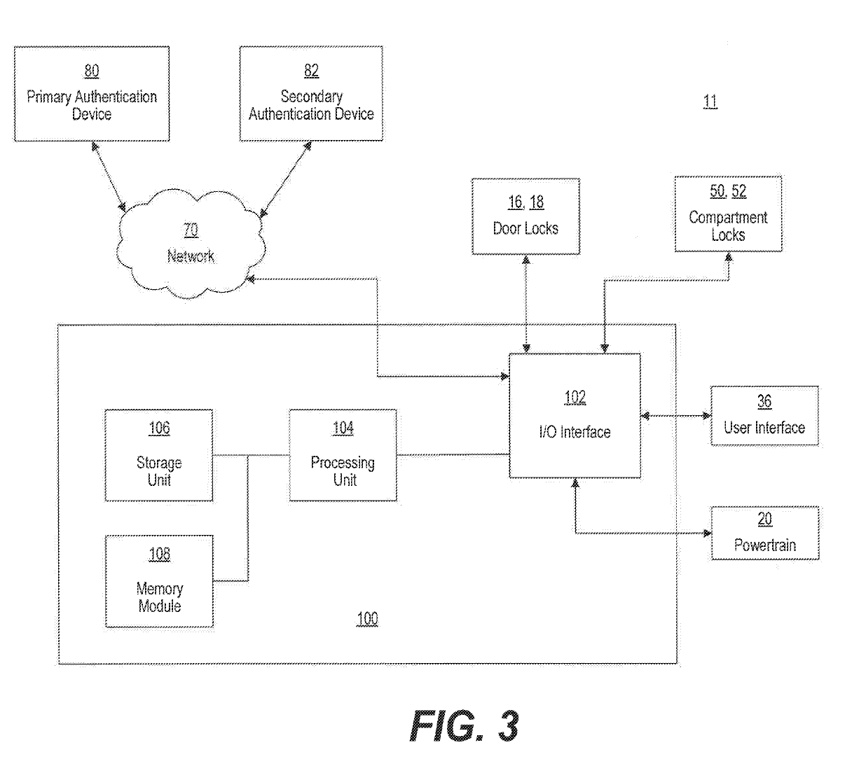

FIG. 3 provides a block diagram of an exemplary authentication control system 11 that may be used in accordance with a method of controlling operation of vehicle 10. As illustrated in FIG. 3, authentication control system 11 may include a controller 100 having, among other things, an I/O interface 102, a processing unit 104, a storage unit 106, and a memory module 108. One or more of the components of controller 100 may be installed in an on-board computer of vehicle 10. These units may be configured to transfer data and send or receive instructions between or among each other.

I/O interface 102 may also be configured for two-way communication between controller 100 and various components of authentication control system 11, such as door locks 16, 18, compartment locks 50, 52, user interface 36, and/or powertrain 20. I/O interface may also send and receive operating signals to and from primary authentication mechanism 80 and secondary authentication mechanisms 82. I/O interface 102 may send and receive the data between each of the devices via communication cables, wireless networks, or other communication mediums. For example, primary and secondary authentication mechanisms 80, 82 may be configured to send and receive signals to I/O interface 102 via a network 70. Network 70 may be any type of wired or wireless network that may allow transmitting and receiving data. For example, network 70 may be a nationwide cellular network, a local wireless network (e.g., Bluetooth™ or WiFi), and/or a wired network.

Processing unit 104 may be configured to receive signals and process the signals to determine a plurality of conditions of the operation of vehicle 10. The processing unit may also be configured to generate and transmit command signals, via I/O interface 102, in order to actuate the devices in communication.

For example, if processing unit 104 detects and successfully authenticates primary authentication mechanism 80 and not secondary authentication mechanism 82, processing unit 104 may be configured to enable a first set of vehicle parameters. The first set of vehicle parameters may enable a “baseline” operation of vehicle 10. For instance, processing unit 104 may be configured to allow the driver to open vehicle doors 12, 14 and may allow the driver to start and operate vehicle 10 with pre-determined performance characteristics. However, the functions and access of the vehicle 10 may be limited in a number of ways.

In some embodiments, the first set of vehicle parameters may restrict access to vehicle doors 12, 14 and/or one or more enclosed areas, such as a hood, a trunk, interior compartments (e.g., dashboard compartment 38 and/or center console compartment 46), and/or any other storage areas of vehicle 10. An exemplary primary authentication mechanism 80 intended for a parking attendant may only allow access to driver side door 12, while preventing access to passenger doors 14 and/or any enclosed areas. Primary authentication mechanism 80 may also control the access of a teenager by preventing the teenager from accessing the contents of dashboard compartment 38 and/or limit occupancy by not allowing access to the passenger doors 14.

In some embodiments, the first set of vehicle parameters may also implement a reduced performance of powertrain 20. In some embodiments, the first set of vehicle parameters may implement a maximum power generated by power source 22, a maximum torque generated by motor 24, and/or a maximum speed of vehicle 10 limiting the vehicle performance depending on the driver. An exemplary primary authentication mechanism 80 intended for a parking attendant may limit the vehicle performance to what is needed for parking situations, such as setting a speed limit to about 25 miles per hour (MPH). However, an exemplary primary authentication mechanism 80 intended for a teenager may limit vehicle performance, such as setting a speed limit to about 65 MPH. It is also contemplated that primary authentication mechanism 80 may provide access of an interior of vehicle 10 to a person (e.g., a child), without allowing that person to operate vehicle 10.

In some embodiments, the first set of vehicle parameters may further restrict access and/or operation of vehicle 10 on a temporal basis. An exemplary primary authentication mechanism 80 may allow access to a parking attendant for a pre-determined length of time that vehicle 10 is within his/her possession. An exemplary primary authentication mechanism 80 may also facilitate a curfew for a teenager, limiting access and/or operation of the vehicle during pre-determined hours of the day.

In some embodiments, the first set of vehicle parameters may even further restrict access to a network of vehicle 10. The network of vehicle 10 may include various connectivity features such as at least one of internet access, cell phone access, and/or in-vehicle network access, such as WiFi, Bluetooth™, CAN bus, or any other vehicle bus architecture protocol that may be used to access features or calibrations within vehicle 10. For example, an exemplary primary authentication mechanism 80 for a parking attendant may prevent access to any of the connectivity features. However, an exemplary primary authentication mechanism 80 intended for a teenager may limit connectivity features to only when vehicle 10 is placed in park. It is also contemplated that an exemplary primary authentication device 80 may provide full access of the network to a person (e.g., a child) while limiting vehicle 10 access in other manners.

However, if processing unit 104 detects the presence of primary authentication mechanism 80 and secondary authentication mechanism 82, and both successfully authenticate, vehicle 10 may enable the second set of parameters. For example, the second set of vehicle parameters may allow “full” unrestricted operation of vehicle 10. However, it is also contemplated that secondary authentication mechanism 82 may provide a second level of access, but additional authentication mechanisms 80, 82 may be required for additional levels of access and/or “full” unrestricted operation of vehicle 10.

In some embodiments, authentication control system 11 may be in communication with multiple individualized authentication mechanisms 80, 82 designed to allow individualized access to features of vehicle 10. Authentication mechanisms 80, 82 may include, for example, a plurality of radio frequency security fobs or signals generated by a mobile communication device, which are pre-programmed to provide various access levels. In some embodiments, authentication mechanisms 80, 82 may provide members of a family to have various levels of access to features of vehicle 10. In some embodiments, authentication control system 11 may be in communication with one or more master authentication mechanisms and one or more minor authentication mechanisms, which emit different signals to the vehicle. For example, a set of family keys may include one or more master keys for the adult(s) and one or more minor keys for the child(ren). The family keys may be pre-programmed such that the minor keys allow access to the entertainment features of the vehicle 10 (e.g., audio system 34 and/or user interface 36) but do not allow vehicle 10 to start. The minor keys may be programmed to further include parental controls on the contents the child(ren) can access.

One or more primary and/or secondary authentication mechanisms 80, 82 may be programmed or re-programmed in a number of different manners. In some embodiments, authentication mechanisms 80, 82 may be programmed or re-programmed through user interface 36 and/or a mobile communication device. For example, user interface 36 and/or a mobile communication device may provide information pertaining to permitted vehicle parameters of each authentication mechanism(s) 80, 82. User interface 36 and/or a mobile communication device may also allow the owner to modify (e.g., add or subtract) vehicle permissions of each authentication mechanism 80, 82. For example, the owner may remotely disable authentication mechanism 80, 82 if it becomes lost or stolen. Furthermore, User interface 36 and/or a mobile communication device may also provide an identity of a current driver of vehicle 10 based on the connectivity of authentication mechanism 80, 82 to vehicle 10.

In some embodiments, primary and/or secondary authentication mechanisms 80, 82 may be programmed by merely transferring data. In some embodiments, programming authentication mechanisms 80, 82 may further include coupling primary and secondary authentication mechanisms 80, 82. In some embodiment, authentication mechanisms 80, 82 may be programmed through scanning an encrypted code. In a first example, primary authentication mechanism(s) 80 may be programmed by providing an encrypted code to be scanned by secondary authentication mechanism 82. For instance, authentication mechanism 82 may be configured to scan a QR code provided by a primary authentication mechanism 80 of a parking attendant, and transmit a corresponding signal to vehicle 10 to notify that a lower vehicle feature access level should be initiated. In a second example, primary authentication mechanism(s) 80 may be programmed by scanning an encrypted code presented on a secondary authentication mechanism 82 (e.g., a mobile communication device). For instance, an owner of vehicle 10 may transmit a primary authentication mechanism 80 to a parking attendant, by allowing the parking attendant to scan a QR code on a mobile communication device of the owner. In either example, the parking attendant may use a universal authentication mechanism for limited access to a plurality of different vehicles, without exchange of a physical authentication mechanism. In some embodiments, the data of authentication mechanisms 80, 82 may also be transferred through communications, such as text messages, emails, and/or sms messages.

Storage unit 106 and/or memory module 108 may be configured to store one or more computer programs that may be executed by controller 100 to perform functions of authentication control system 11. For example, storage unit 106 and/or memory module 108 may be configured to store biometric data detection and processing software configured to determine the identity of individuals based on fingerprint(s). Storage unit 106 and/or memory module 108 may be further configured to store data and/or look-up tables used by the processing unit. For example, storage unit 106 and/or memory module 108 may be configured to include data pertaining to individualized profiles of people pertaining to vehicle 10.

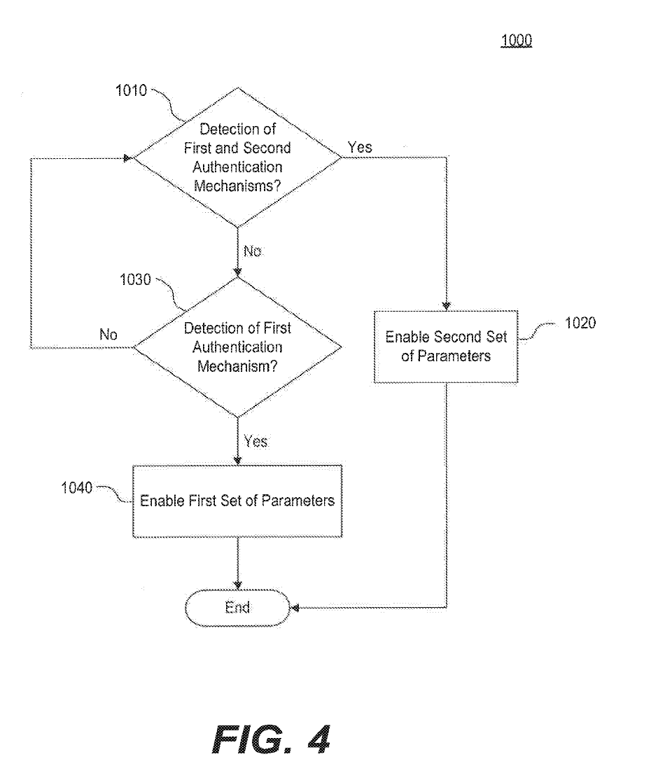

FIG. 4 is a flowchart illustrating an exemplary method 1000 that may be performed by the exemplary authentication control system of FIG. 3. In Step 1010, one or more components of authentication control system 11 may detect primary and secondary authentication mechanisms 80, 82. If primary and secondary authentication mechanisms 80, 82 are detected (“Yes”; Step 1010), controller 100 may enable the second set of parameters in Step 1020. In some embodiments, the second set of parameters may allow “full” unrestricted operation of vehicle 10. For example, the second set of parameters may allow unrestricted access to doors 12, 14 and compartments 38, 46. The second set of parameters may also allow full performance of powertrain 20. The second set of parameter may further permit unrestricted internet access, cell phone access, and/or in-vehicle network access through user interface 36. However, if both primary and secondary authentication mechanisms 80, 82 are not detected (“No”; Step 1010), controller may proceed to Step 1030.

In Step 1030, one or more components of authentication control system 11 may query primary authentication mechanism 80. If primary authentication mechanism 80 is detected (“Yes”; Step 1030), controller 100 may enable the first set of parameters in Step 1040. The first set of parameters may be customized based on the individual accessing vehicle 10. For example, the first set of parameters for a parking attendant may include access limited to driver side door 12, reduced performance of powertrain 20, temporal limitations, and no access to networks of vehicle 10. However, the first set of parameters for a teenager may have different set of limitations including network access limited to when vehicle 10 is stationary.

It is contemplated that Step 1010 and Step 1030 may be performed simultaneously. For example, Step 1020 may be conducted if primary and secondary authentication mechanisms 80, 82 are detected, and Step 1040 may be conducted if primary authentication mechanism 80 is detected without secondary authentication mechanism 82.

Method 1000 may also include programming primary and secondary authentication mechanisms 80, 82. Method 1000 may include programming a primary authentication mechanism 80 according to an identity of a first user of vehicle 10, and a primary and/or a secondary authentication mechanism 80, 82 according to an identity of a second user of vehicle 10. In some embodiments, primary authentication mechanisms 80 may be programmed by coupling primary authentication mechanism 82 with secondary authentication mechanism. For example, primary authentication mechanisms 80 may be programmed by providing an encrypted code to be scanned by secondary authentication mechanism 82.

In some embodiments, primary authentication mechanism 80 (such as a key fob integrated in a phone case) and secondary authentication mechanism 82 (such as a smart phone) may be initially coupled together and carried by a user (or driver) of vehicle 10. By coupling primary authentication mechanism 80 and secondary authentication mechanism 82, the user of vehicle 10 is authorized to access the full or unlimited performance of vehicle 10. When the user arrives at a valet parking service, for example, the user may decouple primary authentication mechanism 80 and the secondary authentication mechanism 82 and give primary authentication mechanism 80 to a parking attendant. By retaining secondary authentication mechanism 82, the user authorizes the parking attendant to access only limited or reduced performance of vehicle 10 as discussed above. The embodiments are not limited to passing vehicle 10 to a parking attendant, as discussed above. For example, the same principle may be applied to passing vehicle 10 by the user to another person to whom the user does not intend to give access to the full performance of vehicle 10.

Another aspect of the disclosure is directed to a non-transitory computer-readable medium storing instructions which, when executed, cause one or more processors to perform the method of authentication, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed control system and related methods. Other embodiments will be apparent to those skilled in the art from consideration of the specification and practice of the disclosed control system and related methods. It is intended that the specification and examples be considered as exemplary only, with a true scope being indicated by the following claims and their equivalents.

What is claimed is:

1. An authentication control system for a vehicle, the authentication control system comprising:
an interface configured to:
receive a first signal generated by a primary authentication mechanism; and
receive a second signal generated by a secondary authentication mechanism; and
a processing unit configured to:
enable a first set of parameters of the vehicle based on receiving the first signal and not the second signal; and
enable a second set of parameters of the vehicle based on receiving the first signal and the second signal, wherein the second set of parameters are different from the first set of parameters.

2. The authentication control system of claim 1, wherein the primary authentication mechanism includes at least one of a radio frequency security fob and/or an access code.

3. The authentication control system of claim 2, wherein the secondary authentication mechanism includes at least one of a smart phone and/or a sensor for detecting biometric data.

4. The authentication control system of claim 1, wherein the first set of parameters provides at least one of access to the interior of the vehicle and/or starting the vehicle.

5. The authentication control system of claim 1, wherein the first set of parameters provides limited access to at least one of a passenger door, an interior compartment, and/or a trunk of the vehicle.

6. The authentication control system of claim 1, wherein the first set of parameters provides a reduced maximum value of vehicle performance.

7. The authentication control system of claim 6, wherein the reduced maximum value of vehicle performance includes at least one of a maximum power, a maximum torque, and/or a maximum speed.

8. The authentication control system of claim 1, wherein the first set of parameters provides limited access and/or operation of the vehicle on a temporal basis.

9. The authentication control system of claim 1, wherein the first set of parameters provides limited access to a network associated with the vehicle.

10. The authentication control system of claim 1, wherein the second set of parameters provides unlimited access to the vehicle.

11. A vehicle comprising:
an authentication control system comprising:
an interface configured to:
receive a first signal generated by a primary authentication mechanism; and
receive a second signal generated by a secondary authentication mechanism; and
a processing unit configured to:
enable a first set of parameters of the vehicle based on receiving the first signal and not the second signal; and
enable a second set of parameters of the vehicle based on receiving the first signal and the second signal, wherein the second set of parameters are different from the first set of parameters.

12. The vehicle of claim 11, wherein the first set of parameters provides a reduced maximum value of vehicle performance including at least one of a maximum power, a maximum torque, and/or a maximum speed.

13. The vehicle of claim 11, wherein the first set of parameters provides limited access and/or operation of the vehicle on a temporal basis.

14. The vehicle of claim 11, wherein the second set of parameters provides unlimited access to the vehicle.

15. A method of authentication for a vehicle, the method comprising:
querying a primary authentication mechanism and a secondary authentication mechanism;
enabling a first set of parameters based on detecting the primary authentication mechanism and not the secondary authentication mechanism; and
enabling a second set of parameters based on detecting the primary authentication mechanism and the secondary authentication mechanism.

16. The method of claim 15,
wherein the first set of parameters provides a reduced maximum value of vehicle performance including at least one of a maximum power, a maximum torque, and/or a maximum speed, and
wherein the second set of parameters provides unlimited access to the vehicle.

17. The method of claim 15, further comprising:
programming the primary authentication mechanism according to an identity of a first user of the vehicle.

18. The method of claim 17, further comprising:
programming the secondary authentication mechanism according to an identity of a second user of the vehicle.

19. The method of claim 17, further comprising:
coupling the primary authentication mechanism with the secondary authentication mechanism.

20. The method of claim 19, wherein programming the primary authentication mechanism includes providing an encrypted code to be scanned by the secondary authentication mechanism.
